(19) United States
(12) Patent Application Publication
(10) Pub. No.: US 2024/0327170 A1
(43) Pub. Date: Oct. 3, 2024

(54) LIFTING TOOL ARRANGEMENT FOR LIFTING A COMPONENT, TOOL FOR SUCH A LIFTING TOOL ARRANGEMENT AND METHOD FOR LIFTING A WIND TURBINE COMPONENT

(71) Applicant: Siemens Gamesa Renewable Energy A/S, Brande (DK)

(72) Inventors: Pedro Dos Santos Duarte Carvalho, Horsens (DK); Klaus Hjorth Hansen, Jelling (DK); Anders Elkjaer Thomsen, Herning (DK)

(21) Appl. No.: 18/576,242

(22) PCT Filed: May 31, 2022
(86) PCT No.: PCT/EP2022/064822

§ 371 Date: Jan. 3, 2024

(30) Foreign Application Priority Data
Jul. 13, 2021 (EP) 21185304.9

(51) Int. Cl. B66C 1/10; B66C 1/66

(52) U.S. Cl. CPC B66C 1/108; B66C 1/66

(57) ABSTRACT

A lifting tool arrangement for lifting heavy components is provided, especially a wind turbine or wind turbine component, including a first tool with a first elongated tool part having an interface adapted to be connected to a lifting device, and a second tool part connected to the first elongated tool part and extending transverse to the first elongated tool part, and a second tool provided at the component, including an opening which is shaped such that, in the lifting position, the first elongated tool part extends through the opening while the second tool part is counter-beared towards an inner surface of the second tool.

### CROSS-REFERENCE TO RELATED APPLICATIONS

This application claims priority to PCT Application No. PCT/EP2022/064822, having a filing date of May 31, 2022, which claims priority to EP application Ser. No. 21/185,304.9, having a filing date of Jul. 13, 2021, the entire contents both of which are hereby incorporated by reference.

### FIELD OF TECHNOLOGY

The following refers to a lifting tool arrangement for lifting a heavy, component, especially a wind turbine or a wind turbine component.

### BACKGROUND

For lifting especially larger or heavy components like an entire wind turbine or a wind turbine component like a turbine blade, a nacelle or a hub, a lifting means or lift in form of a crane is usually used, to which lifting means or lift the component is coupled. The lifting means comprises for example ropes, to which a hook is attached, which hook is inserted for example into a lug arranged at the component.

For lifting wind turbine components, a lifting arrangement is disclosed in EP 3 034 860 B1. The lifting arrangement comprises a tool arrangement with a stem arranged at the lifting device. The stem comprises a circular groove or recess. It is inserted into an opening of the component to be lifted. The inner end of the stem, which is arranged inside of the component, is then finally locked by a controllable locking device, which comprises two half ring locking elements, which engage into the groove or radial recess of the stem, thereby locking it.

Another lifting or tool arrangement for lifting a wind turbine blade is disclosed in U.S. Pat. No. 9,719,487 B2. A frame-like lifting tool is coupled to the lifting device respectively the hook. The frame is provided with several stems, which are inserted in separate bores of the turbine blade. The stems extend through the entire turbine blade and are fixed to the turbine blade by bolts or pins, which are inserted into cross bores of the respective stems.

Finally, WO 2005/071261 discloses a lifting or tool arrangement, adapted to lift a turbine blade. This arrangement comprises two lifting tool elements, which are arranged on the upper and lower outer surface of the blade. They are provided with respective bores, into which respective connection bolts, which extend into respective bores of the turbine blade, and which extend from one tool element to the other, are inserted and fixed to the tool elements, which are firmly attached to the respective blade surface.

The known tool arrangements are complex structures, which involve the provision of several tool elements at the lifting device side and at the component side. Further the arrangement of the respective tool elements or their coupling is complex and cumbersome.

### SUMMARY

An aspect relates to an improved lifting tool arrangement.

For solving the problem, a lifting tool arrangement for lifting heavy components like a wind turbine or wind turbine component is disclosed, comprising:
a first tool with a first elongated tool part having an interface adapted to be connected to a lifting device, and a second tool part connected to the first elongated tool part and extending transverse to the first elongated tool part,
and a second tool provided at the component, comprising an opening which is shaped such that, in the lifting position, the first elongated tool part extends through the opening while the second tool part is counter-beared towards the inner surface of the second tool.

The inventive lifting tool arrangement is simple in its setup and simple in its handling. It comprises a first tool, which has an interface, by which it can be connected to a lifting device, like a respective attachment interface arranged at the ropes of the crane. This interface may for example be or comprise a bore, into which a bolt or pin is inserted, to which for example shackle is coupled, which is connected to a hook of the crane, or to which pin respective cable lugs are attached etc.

To this first elongated tool part, which is for example a longitudinal bar having a rectangular or circular cross section, a second tool part is connected. The cross bar can be an integral part to the center bar, so that the first tool is a one-piece entity. This second tool part extends transverse to the elongated tool part, so that it, depending on the shape of the second tool part, extend to the side of the elongated first tool part.

The arrangement further comprises a second tool, which is provided at the component. This second tool, which may for example be a mechanically stiff plate made for example of metal or the like, which is attached or arranged for example at the turbine blade, or which is an integral part of for example the nacelle or the like, comprises an opening respectively a through hole. This through hole is adapted to receive the first tool respectively is designed such that the first elongated tool part can extend through this opening. The second transverse tool part is arranged such that it is, in the lifting position, counter-beared at the inner surface of the second tool, so that it extends over the opening and abuts the neighbouring inner surface areas and is counter-beared at the inner surface.

In the lifting position, a mechanically stable, while simple connection is realized, which allows for lifting the component, when the first tool is lifted by the lifting device like the crane. The first tool is simple in its setup, as it only comprises the first elongated tool part and the second transverse extending tool part. Also, the second tool is simple in its construction, as it only comprises a respective opening and a sufficiently stable neighbouring area comprising the inner surface, which is designed to counter-bear the second transverse tool part.

For coupling the component to the lifting device, it is only necessary to arrange the first tool such that it extends with its first elongated tool part through the opening and that it is arranged with the second transverse tool part adjacent to the inner surface. By simply pulling the first tool the second transverse tool part is brought into its counter-beared lifting position, so that by further pulling the first tool the component can be lifted.

As mentioned, the second tool may be a separate item, which is arranged and fixated at the component. If the component is for example a turbine blade, the second tool, like a respective metal plate comprising the opening, is firmly fixed to the blade shell, for example by laminating it into the shell structure or by arranging it at the inner shell surface or the like. If the component is for example a nacelle or the hub, either such a separate second tool item can be arranged and fixated at this type of component, for example by welding the metal second tool at the appropriate position to the component. If the component respectively the part which shall be connected to the first tool is stable enough, as it is for example made of metal or the like, it is possible to use this integral component part as the second tool and to provide it with the simple opening, through which the first tool engages. So, there are various simple alternatives to provide the second tool at the component, whatever the component is.

In a first embodiment, the first tool element may be T-shaped with a first elongated tool part in form of a center bar as a first leg and the second tool part in form of a cross bar as second leg, wherein the opening is slit-like and adapted to allow a passage of the cross bar when inserted from an outer surface of the second tool or of the center bar when inserted from the side of the inner surface of the second tool, wherein the cross bar is twisted relative to the opening such that it extends cross to the longitudinal axis of the opening. In this first simple embodiment, the first tool is T-shaped. The first elongated tool part is a center bar, which center bar comprises the interface adapted to be connected to the lifting device. To this center bar a second tool part is attached or integrally connected forming a one-piece element, which is a cross bar, which extends to both sides of the center bar. Both bars or legs are therefore arranged in a T-form. The first tool element therefore is, seen from the side, a slim device. Seen under 90°, the device is quite wide, as the cross bar extends to both sides.

The opening of the second tool this embodiment is slit-like. The width of this slit-like opening is slightly larger than the width of the T-shaped first tool part, seen from the slim side. This allows to insert the first tool, which is for example already attached to the lifting device, from the outer surface through the opening with the cross bar being first inserted into the opening until it is below the inner side, towards which it shall be counter-beared. In an alternative, it is also possible to arrange the first tool from the inner side by pushing the center bar through the opening and then attaching it to the lifting device. However, the first tool is arranged, it is then only necessary to arrange it such that the cross bar extends cross to the longitudinal axis of the opening, so that, when a first tool is lifted, the cross bar is counter-beared against the inner surface.

So, this embodiment is characterized by a simple T-shaped first tool and a second tool comprising a simple slit opening.

Regarding the arrangement of the cross bar, several alternatives are feasible. In a first alternative the cross bar may be firmly attached to the center bar for example by welding or both bars are an integral one-piece. No relative movement of the cross bar to the center bar is possible.

In a second alternative, the cross bar may be twistably arranged at the center bar. This pivotable arrangement allows to twist or pivot the cross bar relative to the non-moving center bar. When the first tool is inserted from the outer surface, it is then only necessary to simply twist the cross bar from its inserting position, in which it is parallel to the longitudinal axis of the opening, into the lifting position, in which is transversed to the longitudinal axis of the opening. This twisting may be performed automatically, when a respective automatic twisting means or twist is provided at the lifting device, which lifting means or lift may for example comprise hydraulic or pneumatic means or device for automatically twisting the cross bar. Alternatively, the twisting may also be done manually from the inside.

In a further alternative, the cross bar may also comprise two cross bar sections, each of which is pivotally arranged at the center bar such that each cross-bar section can be pivoted from a first position, in which it is parallel to the center bar, into a second position, in which it is cross to the center bar. According to this alternative, the shape and size of the first tool may be changed. In the inserting position, the cross-bar sections are in the non-working position, they are pivoted towards the center bar and are for example parallel to it. When the tool is inserted deep enough into the opening, both cross bar sections are pivoted into the working position, in which they extend for example rectangular to the center bar, in which position they are secured or abut each other or the like. In this position, the counter-bearing against the inner surface is possible. If the slit-like opening is wide enough that the first tool in the non-working position may be passed through with the non-working cross bar sections being arranged transverse to the longitudinal axis of the opening, they can then be simply pivoted in the working position and are already correctly orientated rectangular to the longitudinal axis of the opening. Otherwise, a twisting movement is necessary.

Finally, according to a further alternative, the cross bar may also be extendable from a first short form into a second elongated form. Here the cross bar is telescopic and may be changed in its length. This change may be done manually or also automatically, for example controlled via the lifting device by a respective hydraulic or pneumatic actuation means or actuator. Also in this embodiment, a non-working position is given, which allows to easily insert the first tool into and through the bore. When it is finally inserted, it is only necessary to extend or elongate the cross bar to bring it in the working position, which allows the counter-bearing against the inner surface.

As already mentioned, the center bar may have a rectangular or circular cross section. Also, the cross bar may have a rectangular or circular cross section. They are made of metal, steel.

Especially the circular cross section of the cross bar is desired when the inner surface of the second tool is provided with a guiding structure. This guiding structure is adapted to guide the cross bar in a lifting position. Such a guiding structure may for example comprise one or more slanted guiding surfaces or arcuated guiding surfaces or the like. The circular cross bar may simply slide on the guiding structure from the position, where it first abuts the guiding structure, into a final lifting position defined by the guiding structure. So, the cross bar may for example slide on the arcuated guiding surface to the top point of the guiding surface, which defines the final lifting position. This guiding may be performed automatically, as the sliding of the cross bar is easily possible, wherein some lubricant may be provided to further ease this guiding.

Further it is, alternatively or additionally, possible to provide the inner surface with a locking structure or locking element adapted to lock the cross bar in the lifting position, into which it may for example be guided via the guiding structure. This locking ascertains that no unwanted movement of the cross bar out of the final lifting position is possible. The locking structure may for example be a recess or a pocket adapted to receive the cross bar and for example shaped for a kind of form-fit reception of the cross bar, a locking element may for example be a locking wedge or the like.

An alternative embodiment of the setup of the first tool is characterized in that the first elongated tool part is a center bar as a first leg and the second tool part is a disc as the second leg, wherein the center bar is connected to the disc in the center of the disc, and wherein the opening comprises a first opening part having a size adapted to allow a passage of the disc when inserted from an outer surface and of the second tool, and a second opening part being slit-like having a width smaller than the width of the disc such that it extends across the second opening part. Comparable to the first alternative, also this embodiment of the first tool comprises a center bar. But different to the T-shaped embodiment, in this embodiment the second tool part is a disc, for example a circular disc or a rectangular disc, which is attached to the center bar. The center bar and the disc are an integral one-piece device. The center bar is arranged at the disc center, so that a symmetric arrangement is given. The opening in the second tool is differently shaped compared to the opening of the first embodiment. In this second embodiment the opening has a keyhole shape, comprising a first opening part, which is quite large and has a size which is adapted to allow a passage of the disc. If the disc is for example circular, the first opening part is also circular. So, the disc may easily be moved through this first opening part. The opening further comprises a second opening part, which again is longitudinal and slit-like and which directly connects to the first opening part. The width of this slit opening corresponds roughly to the thickness or width of the center bar, as the center bar is moved into and through this slit by a longitudinal movement after inserting the disc in order to bring the first tool in the final lifting position. When moving the first tool and the center bar into the slit opening, the disc is moved under the inner surface, against which it abuts and is counter-beared, when finally the first tool is lifted by the crane.

Also, this embodiment is very simple in its setup, as well regarding the one-piece first tool, which again comprises only two portions, i.e. the center bar and the disc, as regarding the opening, which here has a keyhole shape.

Also, this embodiment may comprise an inner surface which is provided with a guiding and/or locking structure for guiding the disc in a lifting position and/or for locking the disc in the lifting position. The guiding structure may again comprise slanted or arcuated guiding surfaces or slopes, while the locking structure or locking element may comprise a recess or a pocket, adapted to receive the disc desirably in a form fit manner. This recess or pocket may for example also be circular, when a circular disc is used. Also, a locking wedge may be used as a separate locking element.

A third embodiment is characterized in that the first elongated part is a center bar as a first leg and the second tool part is a disc as a second leg, wherein the center bar is connected to the disc in the center of the disc, and wherein the opening has a size adapted to allow a passage of the center bar when inserted from the inner surface of the second tool, and wherein the size of the opening is smaller than the size of the disc such that the disc extends across the opening.

This embodiment is, regarding the setup of the first tool, the same as the second embodiment. Again, the first tool comprises the center bar and the disc attached to the center bar, forming an integral one-piece entity. Different to the second embodiment, in this third embodiment the opening in the second tool is only a small opening corresponding to the size respectively thickness or cross section of the center bar, which is, when the first tool is put in place, moved through this opening from the inside of the component. This may be done manually, with a person lifting the first tool and passing the center bar through the opening, so that it can be connected with its interface to the lifting device at the outside of the component. As the opening is very small and much smaller than the disc, the disc will then automatically be counter-beared at the inner surface, when the first tool is lifted.

Also, this embodiment is very simple in its setup, as again the first tool only comprises the center bar and the disc, and as the opening is just a simple opening and especially a bore, through which the center bar may be passed.

Also, in this embodiment an inner surface may be provided with a guiding and/or locking structure for guiding the disc in a lifted position and/or for locking the disc in the lifting position, so that any movement is prevented. Again, the guiding and/or locking structure may comprise a slandered or arcuated guiding surface or slope or a recess or pocket receiving and locking the disc or a separate locking element.

As mentioned, the first elongated tool part comprises the interface for connecting it to the connection device of the lifting device. This interface may for example be a simple bore extending cross to the longitudinal axis of the first elongated tool part, which bore is adapted to receive a bolt or a pin for fixating a connection means or connector for connecting the first tool part to the lifting device. To this bolt or pin for example a shackle may be fixed, which shackle is then fixed to a hook of the lifting device. Also, a cable sling or a chain may be fixated to the pin. So, there are various possibilities of the setup of the connection device.

The interface may comprise two parallel, flat surfaces provided at the end of the center bar, where the bore is arranged. These flat surfaces allow for a proper engagement of for example a shackle or the like.

According to a further embodiment the second tool part may comprise a coating or a cover made of a material which is softer than the material of the second tool part. As mentioned, the first tool is made of metal respectively steel. In order to avoid any damage of the component to be lifted in the area of the inner surface, at which the second tool part respectively the cross bar or the disc is counter-beared, a respective damping coating or cover may be attached to or provided at the second tool part. This coating or cover, which is for example made of rubber or foam or a comparable softer material, is sandwiched between the inner surface and the metal part of the second tool part, so that the metal second tool part does not directly contact the inner surface. This may be desired when for example the inner surface is provided at a blade and is realized at a blade part made for example of fiber reinforced resin or the like.

The embodiments further includes a first tool for a lifting tool arrangement as mentioned above, comprising a first elongated tool part having an interface adapted to be connected to a lifting device, and a second tool part connected to the first elongated tool part and extending transverse to the elongated tool part.

In a first embodiment, this first tool may be T-shaped with a first elongated tool part in form of a center bar as a first leg and the second tool part in form of a cross bar as the second leg.

The cross bar may be firmly attached to the center bar. But it may also be twistably arranged at the center bar, so that it may be twisted relative to the center bar. In an alternative the first tool may be twistably arrangeable at the lifting device. In another alternative a cross bar may comprise two cross bar sections, each of which is pivotally arranged at the center bar such that each cross-bar section can be pivoted from a first position, in which it is parallel to the center bar into a second position, in which it is cross to the center bar. In yet another alternative the cross bar may be extendable from a first short form into a second elongated form.

In an embodiment, the cross bar has a cylindrical cross section, which, as mentioned above, is desired especially for an automatic movement or guiding into the lifting position when in contact with the inner surface of the second tool.

In an alternative the first elongated tool part again is a center bar as a first leg and the second tool part is a disc as the second leg, wherein the center bar is connected to the disc in the center of the disc.

The interface of the first elongated tool part may be a bore extending cross to the longitudinal axis of the first elongated tool part and adapted to receive a bolt or a pin for fixating a connection means for connecting the first tool part to the lifting device.

The second tool part may comprise a coating or a cover made of a material which is softer than the material of the second tool part.

Finally, the embodiments include a method for lifting a wind turbine component, especially a turbine blade or a nacelle or a hub, using a lifting tool arrangement as mentioned above, comprising the steps of:
Passing the first tool coupled to or to be coupled to the lifting device through the opening of the second tool arranged at the component with the first elongated tool part extending through the opening and with the second tool part being arranged adjacent to the inner surface of the second tool,
Counter-bearing the second tool part against the inner surface of the second tool, and
Pulling the first tool with the lifting means for lifting the component.

As already mentioned in the discussion of the inventive lifting tool arrangement, the first tool may be inserted into the opening from the outside, when the opening allows a passage of the second tool part of the first tool. In an alternative it is also possible to move the first tool through the opening from the inside, with the center bar extending through the opening. No matter how the first tool is arranged respectively moved to the opening, in the final position the first tool part respectively the center bar extends through the opening with the interface being at the outside and the second tool part, be it the cross bar or the disc, being arranged adjacent to the inner surface, against which it is then counter-beared when the first tool is lifted.

### BRIEF DESCRIPTION

Some of the embodiments will be described in detail, with references to the following Figures, wherein like designations denote like members, wherein:

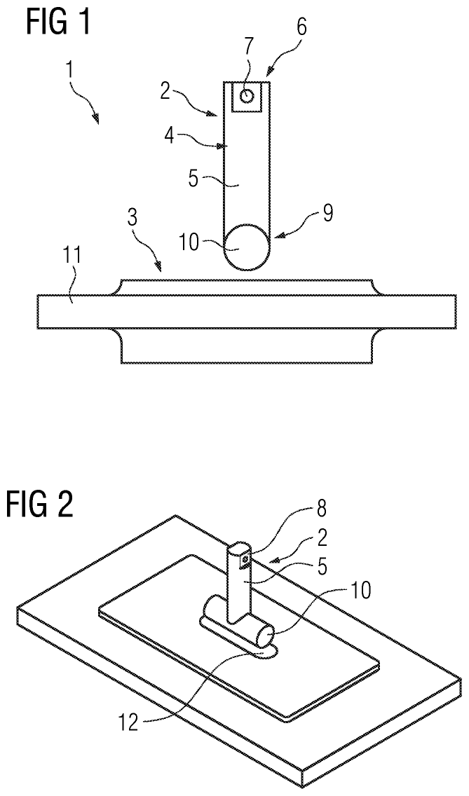

FIG. 1 shows various principle illustrations showing a first embodiment of a lifting tool arrangement with a T-shaped first lifting means or T-shaped first lift and a second lifting means or second lift with a slit-like opening;

FIG. 2 shows various principle illustrations showing a first embodiment of a lifting tool arrangement with a T-shaped first lifting means or T-shaped first lift and a second lifting means or second lift with a slit-like opening;

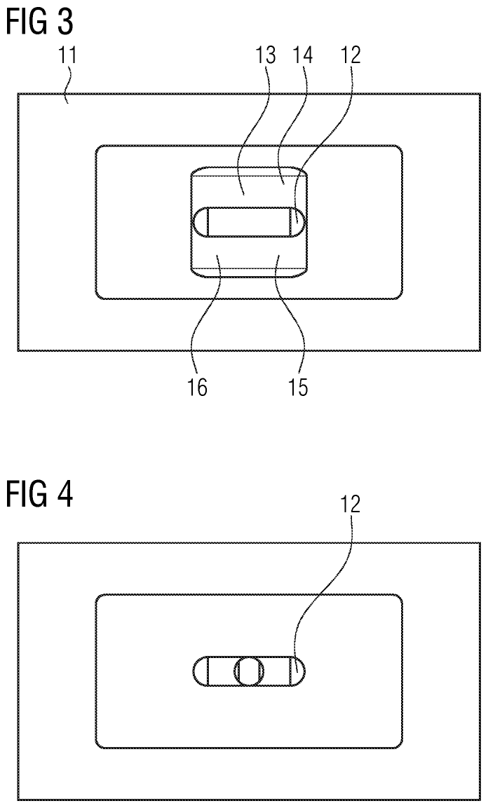

FIG. 3 shows various principle illustrations showing a first embodiment of a lifting tool arrangement with a T-shaped first lifting means or T-shaped first lift and a second lifting means or second lift with a slit-like opening;

FIG. 4 shows various principle illustrations showing a first embodiment of a lifting tool arrangement with a T-shaped first lifting means or T-shaped first lift and a second lifting means or second lift with a slit-like opening;

FIG. 5 shows various principle illustrations showing a first embodiment of a lifting tool arrangement with a T-shaped first lifting means or T-shaped first lift and a second lifting means or second lift with a slit-like opening;

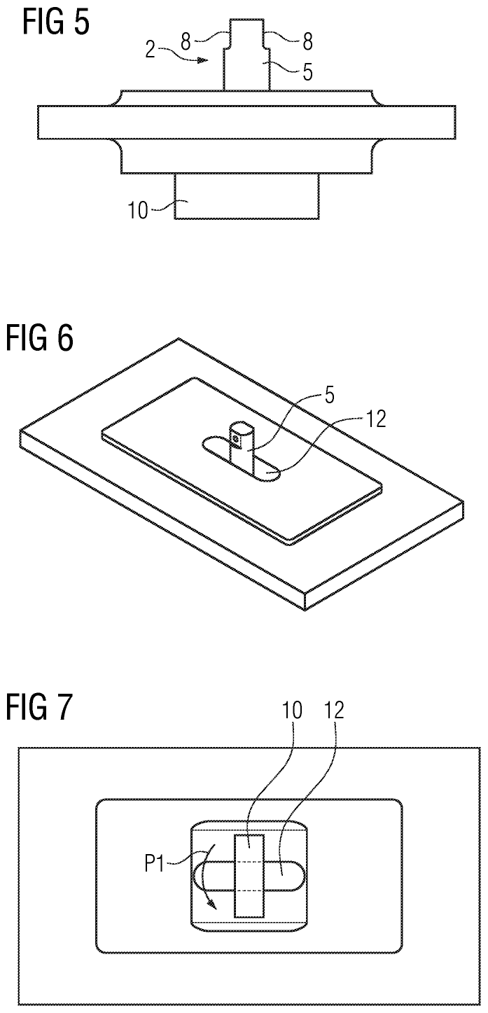

FIG. 6 shows various principle illustrations showing a first embodiment of a lifting tool arrangement with a T-shaped first lifting means or T-shaped first lift and a second lifting means or second lift with a slit-like opening;

FIG. 7 shows various principle illustrations showing a first embodiment of a lifting tool arrangement with a T-shaped first lifting means or T-shaped first lift and a second lifting means or second lift with a slit-like opening;

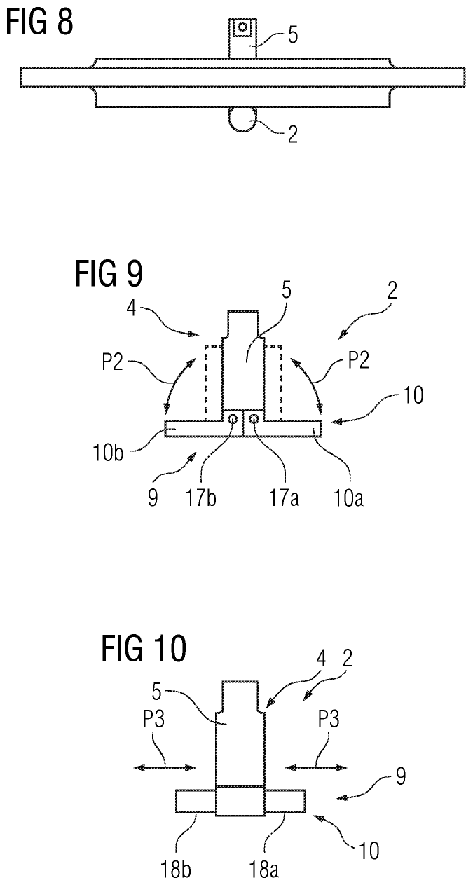

FIG. 8 shows various principle illustrations showing a first embodiment of a lifting tool arrangement with a T-shaped first lifting means or T-shaped first lift and a second lifting means or second lift with a slit-like opening;

FIG. 9 shows a principle illustration of another alternative of a first lifting means or first lift which may be used in a lifting tool arrangement of the FIGS. 1-8;

FIG. 10 shows a principle illustration of a second lifting means which may be used in a lifting tool arrangement of the FIGS. 1-8;

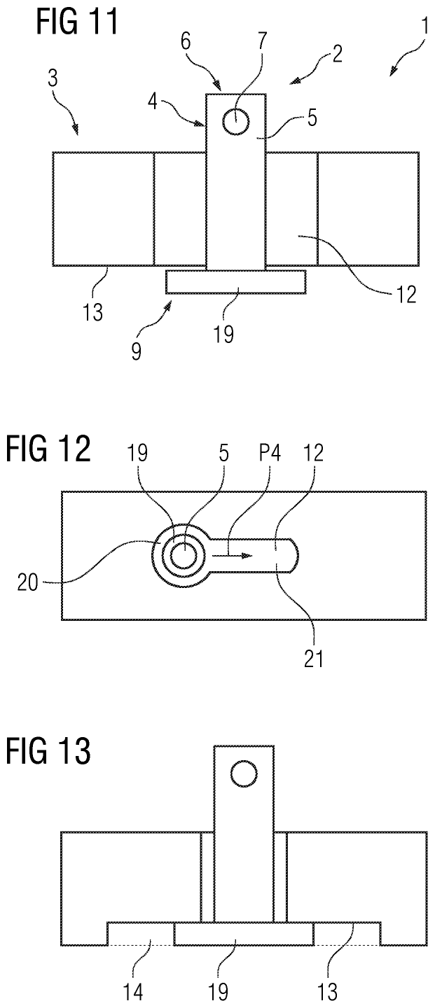

FIG. 11 shows various illustrations of a lifting tool arrangement of a second embodiment with a first tool comprising a disc and a second tool comprising a keyhole shaped opening;

FIG. 12 shows various illustrations of a lifting tool arrangement of a second embodiment with a first tool comprising a disc and a second tool comprising a keyhole shaped opening;

FIG. 13 shows various illustrations of a lifting tool arrangement of a second embodiment with a first tool comprising a disc and a second tool comprising a keyhole shaped opening;

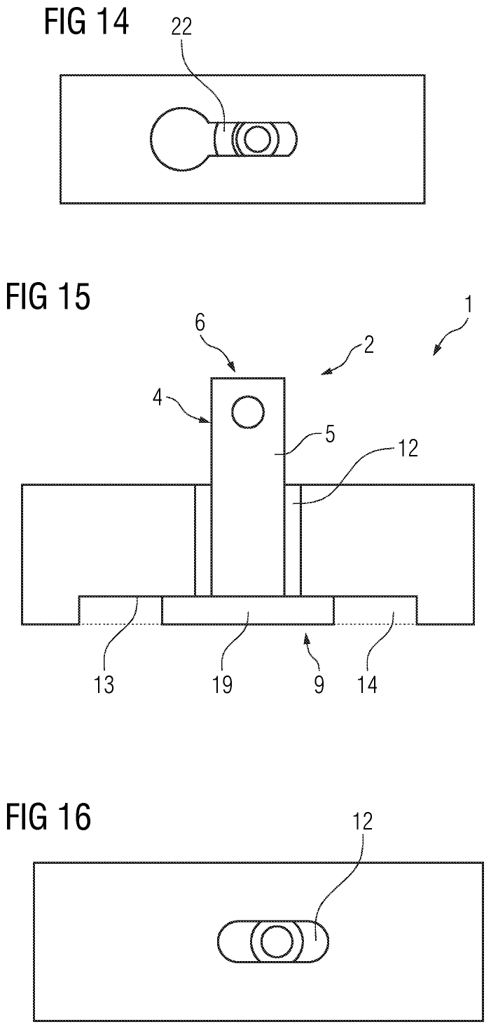

FIG. 14 shows various illustrations of a lifting tool arrangement of a second embodiment with a first tool comprising a disc and a second tool comprising a keyhole shaped opening;

FIG. 15 shows a principle illustration of a third embodiment of a lifting tool arrangement with a first tool comprising a disc and a second tool only comprising a small bore or slit like opening; and

FIG. 16 shows a principle illustration of a third embodiment of a lifting tool arrangement with a first tool comprising a disc and a second tool only comprising a small bore or slit like opening.

### DETAILED DESCRIPTION

FIGS. 1-8 show a first embodiment of an inventive lifting tool arrangement 1, comprising a first lifting tool 2 and a second lifting tool 3. The first lifting tool in this embodiment is T-shaped with a first elongated tool part 4, which is a center bar 5 having for example a circular cross section. At the free end of the center bar 5 and interface 6 is provided adapted to realize a connection with a connection means or connector a lifting device like a crane. The interface 6 comprises a bore 7 extending cross to the longitudinal axis of the center bar 5. The bore 7 is arranged in an area of two parallel flattened surfaces 8, as shown for example in FIGS. 1 and 5.

The first tool further comprises a second tool part 9 in form of a cross bar 10, which is attached to the opposite end of the center bar 5, so that it extends to both sides of the center bar 5 and finally builds the T-form. So, the center bar 5 is a first leg and the cross bar 10 is a second leg.

The second tool 3 in this embodiment is for example a plate 11, which, as the first tool 2, is made of metal and is arranged at the component to be lifted. If the component is for example a turbine blade, this metal plate 11 may be laminated into the blade shell structure or may be attached at the inner side of the blade shell. If the component is a metal component like a nacelle or the like, the metal plate 11 may be fixated to the component for example by welding or screwing. Finally, the metal plate 11 may also be an integral part of the component, for example a metal wall element or the like.

The second tool is provided with an opening 12, which in this embodiment, see for example FIGS. 3 and 5, is slit-like. It has a width which is slightly larger than the width of the first tool 2, as shown in the orientation of FIG. 1, so that the first tool 2 respectively the circular cross bar 10 and the circular center bar 5 may be pushed through the opening 12.

The second tool 3 respectively the plate 11 further comprises an inner surface 13, which in this embodiment is provided with the recess 14 having a guiding structure 15 here in form of a curved or arcuated surface 16, as shown in FIGS. 3 and 7. The inner surface 13 is the surface at which the cross bar 10 is finally counter-beared in the lifting position, wherein the guiding structure 15 respectively the arcuated surface 16 finally guides the cross bar 10 and therefore the first tool 2 in the final lifting position.

For coupling the lifting device to the component, the lifting device, to which the first tool 2 is already attached, lowers the first tool 2, so that the cross bar 10 and the center bar 5 are moved through the opening 12, as shown in the figures. The first tool 2 is lowered, until the cross bar 10 is below the inner surface 13. Now the first tool 2 is twisted for 90°, as shown in FIG. 5 compared to FIG. 3, so that the cross bare 10 extends transverse to the longitudinal axis of the opening, as shown in FIG. 7. When now the lifting device lifts the first tool 2, the cross bar 10 abuts the inner surface 13. The guiding structure 15 respectively the arcuated surface 16 now finally allows the cross bar 10 to slightly move along the arcuated surface 16 until it reaches the uppermost surface point which defines the final lifting position. When now the lifting device further moves the first tool 2, the coupled component is lifted.

The twisting of the first tool 2 may be done automatically, for example by an automatic twisting means arranged in the coupling of the first tool 2 to the connection device of the lifting device. This twisting means may for example be a hydraulic or pneumatic twisting means. In an alternative the twisting may also be done manually either from the outside or from the inside of the component.

As indicated by the dashed arrow P1 in FIG. 7, it is also possible to arrange the cross bar 10 pivotable at the center bar 5, so that the cross bar 10 can be freely rotated relative to the center bar 10. This allows to solely twist the cross bar 10 from the inside of the component in order to bring it into the transverse position without moving the center bar 5.

FIG. 9 shown an alternative setup of the first tool 2. In this embodiment again a first elongated tool part 4 in the form of a central bar 5 is provided, at which a second tool part 9 in form of a cross bar 10 is arranged. In this embodiment the cross bar 10 comprises two cross bar sections 10a, 10b, which are pivotably attached at the center bar 5 and pivot around respective pivot axis 17a, 17b. This allows to pivot the cross-bar sections from the shown lifting position, in which they extend to both sides of the center bar 5, into a non-working position, which is shown by the dashed lines, in which they are arranged parallel to the center bar 5. This pivot movement is shown by the arrows P2.

For the insertion of the first tool 2 into the opening 12 the cross-bar sections 10a, 10b are in the non-working position. After passing through the opening 12, they are pivoted into the working position as shown in FIG. 9, thereby automatically overlapping with the inner surface 13, against which they are then finally counter-beared. In this embodiment, the opening 12 not necessarily needs to be slit-like but may also be a simple bore having a dimension which allows to insert the first tool in the non-working position.

FIG. 10 shows another embodiment of a first tool 2 again comprising a first elongated tool part 4 in the form of a center bar 5 and a second tool part 9 in the form of a cross bar 10. This cross bar 10 is extendable, it is a telescopic bar, having two bar elements 18a, 18b, which can be linearly moved, as shown by the arrows P3. They can be moved from an inner non-working position into the shown lifting position, in which they extend to the sides of the center bar 5. Again, the first tool 2 may be moved through the opening 12 with the cross-bar elements 18a, 18b being in the non-working position, after which, when the cross bar 10 is below the inner surface 13, they are automatically extended in their working position allowing to engage the inner surface 13.

FIGS. 11-14 show another embodiment of a lifting tool arrangement 1, again comprising a first tool 2 with a first elongated tool part 4 in the form of a center bar 5 with an interface 6 comprising a bore 7 arranged at the flat surface areas.

To the center bar 5 a second tool part 9 in form of a disc 19 is integrally formed, as again the elements are made of metal. In some embodiments, welding the disc to the center bar is possible. The center bar 5 is arranged in the center of the disc 19, as shown in FIG. 12.

The second tool 3, which is again only shown in principle, and which may be a separate element attached to the component to be lifted, or which may be an integral element of the component to be lifted, comprises an opening 12, which in this embodiment, see FIG. 12, has a keyhole shape. It comprises a first opening part 20, which in this embodiment corresponds to the circular shape of the disc 19 and is also circular but has a larger diameter than the diameter of the disc 19. To the first opening part 20 a second opening part 21 is connected, which is slit-like and which has a width which is smaller than the diameter of the disc 19.

For connecting the lifting device to the component, the first tool 2 is lowered and the disc 19 and the center bar 5 are moved through the first opening part, until the disc 19 is below the inner surface 13 of the second tool 3. Now, see FIG. 12 which shows a top view of the arrangement of FIG. 11, the first tool 2 is horizontally moved, as shown by the arrow P4, so that the center bar 5 is moved into the second slit-like opening part 21. When moving it into the opening part 21, the disc 19 is automatically moved underneath the inner surface 13, which is provided with a recess 14, which accommodates the disc 19 and which is also a locking means or lock, as it prevents the disc 19 from moving out of the recess when engaged.

When the first tool 2 is moved to the side the first tool 2 is lifted, so that the disc 19 is moved into the recess and counter-beared at the inner surface 13, so that the tool is engaged. When now the first tool is further lifted, also the component is lifted.

FIG. 14 shows the possibility to additionally insert a locking element 22 like a wedge or the like in the opening part 21, which prevents the first tool 2 from a further horizontal movement.

The embodiment of FIGS. 15 and 16 show a lifting tool arrangement 1, again comprising a first tool 2 with a first tool part 4 in form of a center bar 5 and a second tool part 9 in form of a disc 19. In this embodiment the opening 12 as shown in FIG. 16, which is a top view of the arrangement of FIG. 15, is only slit-like and has a width which is smaller than the diameter of the circular disc 19. In this embodiment the first tool 2 is positioned from the inside of the component. The first tool, which is not yet coupled to the lifting device, is moved with the center bar through the opening 13 from the inner side respectively the side of the inner surface 13, until the connection interface 6 can be connected to the connection means or connector the lifting device at the outside of the component. The first tool 4 is then lifted, so that the disc 19 is moved against the inner surface 13, where it is counter-beared, so that finally the component can be lifted.

Again, a recess 14 may be provided, in which the inner surface 13 counter-bearing the disc 19 is provided.

Finally, the second tool part 9, be it the cross bar 10 or the disc 19, may be provided with a coating or a cover, which acts as a damping means or damper, as it is made of a material which is softer than the metal material of the second tool part. This coating or cover is sandwiched between the cross bar 10 or the disc 19 and the inner surface 13 in order to prevent any damage resulting from a direct contact.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A lifting tool arrangement for lifting a component, comprising:
a first tool with a first elongated tool part having an interface configured to be connected to a lifting device, and a second tool part connected to the first elongated tool part and extending transverse to the first elongated tool part, wherein the first elongated tool part is a center bar as a first leg and the second tool part is a crossbar as a second leg with the first tool having a T-shape, or wherein the second tool part is a disc as a second leg with the center bar being connected to the disc in the center of the disc; and
a second tool provided at the component, comprising an opening which is shaped such that, in the lifting position, the first elongated tool part extends through the opening while the second tool part is counter-beared towards an inner surface of the second tool, wherein the inner surface is provided with a guiding and/or locking structure for guiding the cross bar or the disc in a lifting position and/or for locking the cross bar or the disc in the lifting position.

2. The lifting tool arrangement according to claim 1, wherein the first tool is T-shaped with the first elongated tool part in form of a center bar as a first leg and the second tool part in form of a cross bar with a circular cross section, as a second leg, wherein the opening is slit-like and configured to allow a passage of the cross bar when inserted from an outer surface of the second tool or of the center bar when inserted from the side of the inner surface of the second tool, wherein the cross bar is twisted relative to the opening such that it extends cross to the longitudinal axis of the opening.

3. The lifting tool arrangement according to claim 2, wherein the cross bar is twistably arranged at the center bar, or that the first tool is twistably arrangeable at the lifting device, or that the cross bar comprises two cross bar sections, each of which is pivotally arranged at the center bar such that each cross bar section can be pivoted from a first position, in which it is parallel to the center bar, into a second position, in which it is cross to the center bar, or that the cross bar is extendable from a first short form into a second elongated form.

4. The lifting tool arrangement according to claim 1, wherein the first elongated tool part is a center bar as a first leg and the second tool part is a disc as the second leg, wherein the center bar is connected to the disc in the center of the disc, and wherein the opening comprises a first opening part having a size configured to allow a passage of the disc when inserted from an outer surface of the second tool, and a second opening part being slit-like having a width smaller than the width of the disc such that it extends across the second opening part.

5. The lifting tool arrangement according to claim 1, wherein the first elongated tool part is a center bar as a first leg and the second tool part is a disc as a second leg, wherein the center bar is connected to the disc in the center of the disc, and wherein the opening has a size adapted configured to allow a passage of the center bar when inserted from the side of the inner surface of the second tool, and wherein the size of the opening is smaller than the size of the disc such that the disc extends across the opening.

6. The lifting tool arrangement according to claim 1, wherein the guiding and/or locking structure comprises a slanted or arcuated guiding surface or a recess for pocket receiving and locking the cross bar or the disc.

7. The lifting tool arrangement according to claim 1, wherein the interface of the first elongated tool part is a bore extending cross to the longitudinal axis of the first elongated tool part and configured to receive a bolt or pin for fixating a connector for connecting the first tool part to the lifting device.

8. The lifting tool arrangement according to claim 1, wherein the second tool part comprises a coating or a cover made of a material which is softer than the material of the second tool part.

9. A method for lifting a wind turbine component, using a lifting tool arrangement according to claim 1, comprising:
passing the first tool coupled to or to be coupled to the lifting device through the opening of the second tool means arranged at the component with the first elongated tool part extending through the opening and with the second tool part being arranged adjacent to the inner surface of the second tool;
counter-bearing the second tool part against the inner surface of the second tool means; and
pulling the first tool with the lift for lifting the component.

10. A wind turbine or wind turbine component having the lifting tool arrangement for lifting a component of claim 1.

11. The method for lifting the wind turbine component of claim 1, wherein the wind turbine component is a turbine blade, a nacelle or a hub.
